(19) United States
(12) Patent Application Publication
(10) Pub. No.: US 2004/0205637 A1
(43) Pub. Date: Oct. 14, 2004

(54) Methods and systems for dynamic display of information in an internet application

(76) Inventor: Evan Witt, Chicago, IL (US)

Correspondence Address: Finnegan, Henderson, Farabow,, Garrett & Dunner, L.L.P., 1300 I Street, N.W., Washington, DC, 20005-3315, US

(21) Appl. No.: 10/178,842

(22) Filed: Jun. 25, 2002

(51) Int. Cl. G06F 17/24

(52) U.S. Cl. 715/526

(57) ABSTRACT

Methods and systems consistent with the present invention provide graphical elements for the dynamic display of information, such as, sliding bars, in an Internet Application. The method includes selecting the segment with representative information and moving the segment, where the representative information is modified. A further method includes creating a segment with associated information, validating the associated information, and displaying the segment on the web interface.

### FIELD

This invention relates generally to the dynamic display of information, and, more particularly, to the dynamic display of information using graphical elements such as, segments, in an internet application.

### BACKGROUND

The use of electronic media to convey information among networked users has become vital in many applications. For example, the ability to view data on a visual medium, such as a computer display, has become increasingly important for many personal and business related applications due to the advances in network technology. One type of network technology is the Internet. The Internet has experienced exponential growth fueled by the phenomenal popularity of the World Wide Web (the “web”). On the web, the ease of self-publication via user-created “web pages” has helped generate tens of millions of documents on a broad range of subjects, all capable of being displayed visually for a computer user with access to the web.

Users can access such information using standard computer equipment, such as a personal computer with a display and modem connected to the Internet. Several types of Internet connections are available, including connections through Internet Service Providers (ISPs). To use an Internet connection from an ISP, for example, a user can electronically connect his personal computer to a server at the ISP's facility using the modem and a standard telephone line or a local area network (LAN) connection. The ISP's server in turn provides the user with access to the Internet.

Typically, a user accesses information using a computer program called a “web browser.” A web browser provides an interface to the web. Examples of web browsers include Netscape Navigator™ from Netscape Communications Corporation or Internet Explorer™ from Microsoft Corporation. To view a web page, the user uses the web page's Uniform Resource Locator (URL) address for the web browser to access the web page. The user, via the web browser, can view or access an object in the web page, for example, a document containing information of interest. The web browser retrieves the information and visually displays it to the user.

A web page can be a document, and the information contained in the web pages is commonly referred to as “content.” The URL address identifies a location of a web page, typically stored on a server (“web server”). The web server handles requests from a web browser. One form of facilitating content on the web via a web browser is Internet Applications. Internet Applications are software applications that are run over the Internet, through the web browser.

Internet Applications have several advantages over standard software applications. Internet Applications may take the processing load off of an user's computer. For example, a version of Adobe® Photoshop® may work best with 512 MB of RAM and 2 GHz processor and a large amounts of disk space. By making this desktop software program an Internet Application, a user would not need to meet these requirements. They may only need a moderately good computer and an Internet connection. Internet Applications can store files on a central server, further allowing users to work from any terminal instead of only their home or work computer. The ease of sharing data, maintaining and upgrading, scalability and accessibility, make Internet Applications important development direction in software development. The interface to a user provided by a browser is becoming a standard interface that is more comfortable for a user then desktop software. The web interface takes advantage of the use of html and javascript to standardize across user's computer platforms.

Internet Applications continue to evolve. Developments in hardware and software are advancing to support more complex Internet Applications, but there exists a need for easier display of information and tools to help in the development of Internet Applications.

Typically, user interfaces for accessing information available on the over the Internet is based on a physical or sensory connection between a user and a computer. The display on a user interface is important to the usefulness and accessibility of information. The languages that create and support these interfaces, such as HTML and javascript, are not as fast as desktop languages, such as C and C++. The internet interface languages are not compiled into executables. Further, Internet Applications suffer from security limitations, less control in development options, and loose standards, which make the job of the Internet developer harder. Specifically, it is difficult to develop dynamic software, which includes elements such as sliding bars. There exists, therefore, a need to provide users with dynamic interfaces, such as sliding bars, and tools to develop the dynamic interfaces, which and enhance the development and use of Internet Applications.

### SUMMARY

Consistent with the invention, one method is disclosed for a client to receiving into a web page, a segment with information. The client receives code for manipulating the segment, and the code for manipulating the segment receives a manipulation command. The client displays the manipulation of the segment in the web page.

Another method is disclosed for a server to provide a web page. The server provides code for inserting into the web page a segment with information. The server inserts code for manipulating the segment, where the code for manipulating the segment receives a manipulation command. The server inserts code for displaying the manipulation of the segment on the web page.

Another method is disclosed for dynamically manipulating a segment in an Internet Application. The method includes selecting the segment with representative information and moving the segment, where the representative information is modified.

Another method is disclosed for visually displaying information on a web interface. The method includes creating a segment with associated information, validating the associated information, and displaying the segment on the web interface.

### BRIEF DESCRIPTION OF THE DRAWINGS

The accompanying drawings, which are incorporated in, and constitute a part of the specification, illustrate exemplary implementations of the invention and, together with the detailed description, serve to explain the principles of the invention. In the drawings,

FIG. 1 is a block diagram of an exemplary system architecture in which methods and systems consistent with the invention may be implemented;

FIG. 2 is an internal block diagram of an exemplary computer system in which methods and systems consistent with the invention may be implemented;

FIG. 3 is a graphical depiction of exemplary graphical elements;

FIG. 4 is a graphical depiction of an exemplary interface for displaying an Internet Application;

FIG. 5 is a graphical depiction of a cut out section of FIG. 4;

FIG. 5 is a flow diagram of a method for manipulating elements; and

FIG. 6 is a flow diagram of a method for verifying the movement of elements.

### DETAILED DESCRIPTION

Reference will now be made in detail to exemplary implementations of the invention, examples of which are illustrated in the accompanying drawings. Wherever possible, the same reference numbers will be used throughout the drawings to refer to the same or like parts.

Methods and systems consistent with the present invention provide graphical elements for the dynamic display of information, such as, sliding bars, in an Internet Application. Bars are displayed on a web page. Information is associated with the bar position. The bars can be manipulated, by sliding the bar from one position to another position, lengthening the bar, or shortening the bar. When the bar position changes, the information associated with the bar changes. The changed information may then be updated in a database. An example of this is a scheduling application having the bar represent a work shift. The position of the bar indicates the time a worker is scheduled to work. If the bar is moved to a new time, the new time schedule information will be stored in a database. The stored information can then be used by other applications, such as the payroll system. In another embodiment, bar movement may be limited by rules. A web page of an Internet Application may have built in rules associated with the bars. These rules may be used to control or to limit bar movement. When a bar is moved, the new information associated with the moved position is checked against the rule, to verify the movement is an allowed movement. In the scheduling application, an example of this is preventing the movement of a standard shift bar into a position already occupied by a shift bar.

The bars can be used to rearrange and simplify tabulated lists, schedules, graphs, diagrams and maps in a way that can reveal otherwise hidden relationships and patterns. The bars can be moved from one position to another position on the page. The bars can be used in schedules, briefs, vacation, itineraries, meeting notes, to do lists, and many other applications that require the display and rearrangement of data on a computer monitor or screen. The bars can be segments on a screen that can represent tasks, jobs, time interval or other information on a monitor.

The following implementations are described as being implemented in a scheduling application. Nevertheless, the following implementations can be implemented for other types of Internet applications. Internet applications do not require any installation, and thus function entirely over the Internet. Examples of these Internet Applications may include applications for a physical layout of operations, a team calendar, an adjustable bar graph, a music equalizer or volume control, a brightness control on a photo editor, or an application for representing integrals of mathematical functions.

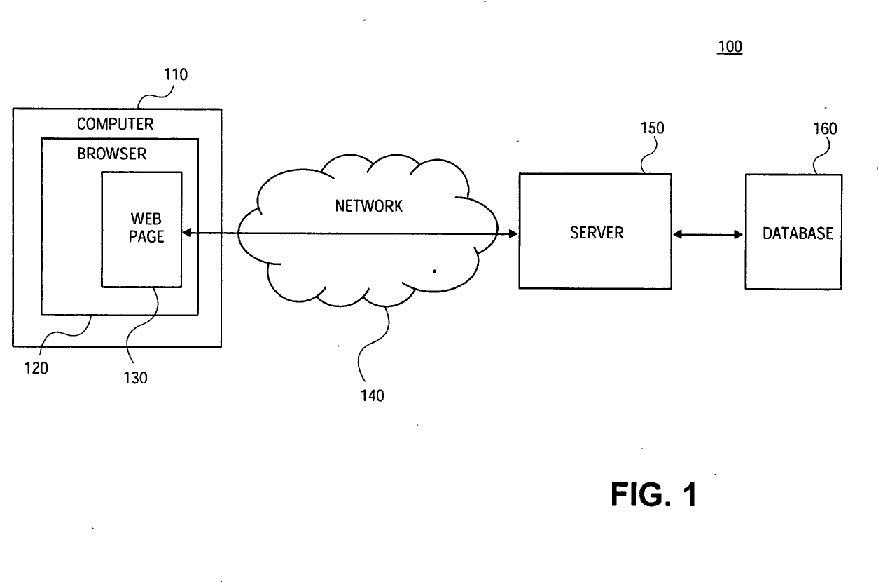

FIG. 1 is a block diagram of exemplary system architecture 100 in which methods and systems consistent with the invention may be implemented. System architecture 100 includes computer 110 and server 150 connected via network 140. Connected to server 150 is database 160. Computer 110 runs a browser 120, which displays a web page 130. Network 140 may be a wide area network (WAN), a local area network (LAN), or a proprietary network, that provides access to the Internet.

The computer 110 may be a personal computer, such as an Apple Power Macintosh or a Pentium-based personal computer running a version of the Windows® operating system. Web page 130 can be displayed on a display or monitor of computer 110 via browser 120. Browser 120 can receive web page 130 or other data using a standard Hypertext Markup Transfer Protocol (HTTP) or other

Browser 120 is a software application used to locate and display web page 130. Examples of browser 120 include, Netscape Navigator and Microsoft® Internet Explorer, graphical web browsers that display graphics, images, and text. Web page 130 can includes a document for access on the web. Web page 130 may be created using Hypertext Markup Language (HTML) or generated using scripting. Examples of pages created from scripting are active server pages (asp pages) and Java server pages (jsp pages). More specifically, the asp or jsp generates a combination of HTML and javascript code. Microsoft's version of javascript is called jscript, but the language is more widely referred to as javascript. Asp pages can dynamically create the client-side HTML and javascript needed for a web page, by utilizing server-side scripting, with a language such as Visual Basic (“VB”). When browser 120 requests an asp page, server 150 generates web page 130 with HTML/javascript code and sends it back to browser 120. Jsp pages are similar to asp pages and have dynamic scripting capability that work in tandem with HTML code, separating the page logic from the static elements (e.g. the actual design and display of the page). Embedded in the jsp page, the Java source code makes the HTML more dynamic, for example by providing up-to-date data from database queries.

Server 150 is a computer that provides and delivers web page 130 to computer 20 or other computers connected to network 140. Server 150 has an associated IP address and/or a domain name. For example, the URL http://www.inter.net/schedule.html is entered into browser 120, browser 120 sends a request to server 150, which may have a domain name of “inter.net.” Server 150 can fetch web page 130 with the name “schedule.html” and send it to browser 120 for display on computer 110. Server 150 may operate with software applications including public domain software from NCSA and Apache and commercial packages from Microsoft, Netscape, etc. Server 150 can be a single server or a set of multiple servers.

Server 150 stores information in database 160. Database 160 allows for the storage of information and for uniquely identifying, organizing and referencing data and a system or mechanism for retrieving them from the network. Database 160 can be a database management system (DBMS), which is a collection of programs enabling the storage, modification, and extraction of information from a database. There are many different types of DBMSs, ranging from small systems that run on personal computers to huge systems that run on mainframes. Database applications include, computerized library systems, automated teller machines, flight reservation systems, computerized parts inventory systems, scheduling systems, or other systems.

Requests for information from a database are made in the form of a query, which is a stylized question. For example, the query:

SELECT ALL WHERE NAME=“SMITH” AND AGE>35

requests all records in which the NAME field is SMITH and the AGE field is greater than 35. The set of rules for constructing queries is known as a query language. Different DBMSs support different query languages, although there is a semi-standardized query language called SQL (structured query language).

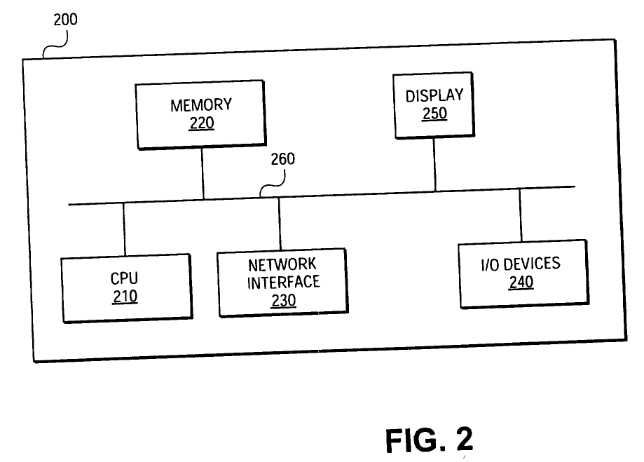

FIG. 2 is an internal block diagram of an exemplary computer system 200 in which methods and systems consistent with the invention may be implemented. Computer system 200 may represent the internal components of the users, storage systems or servers of exemplary system architecture 100 in FIG. 1. In one embodiment, a web browser for displaying web pages, consistent with the invention, may be implemented in computer system 200.

Computer system 200 may be, for example, a conventional personal computer (PC), a desktop and hand-held device, a multiprocessor computer, a pen computer, a microprocessor-based or programmable consumer electronics, a minicomputer, a mainframe computer, a personal mobile computing device, a mobile phone, a portable or stationary personal computer, a palmtop computer or other such computers known in the art.

Computer system 200 includes CPU 210, memory 220, network interface 230, I/O devices 240, display 250, all interconnected via a system bus 260. As shown in FIG. 2, computer system 200 contains a central processing unit (CPU) 210. CPU 210 may be a microprocessor such as the Pentium® family of microprocessors manufactured by Intel Corporation. However, any other suitable microprocessor, micro-, mini-, or mainframe computer may be used, such as a micro-controller unit (MCU), digital signal processor (DSP).

Memory 220 may include a random access memory (RAM), a read-only memory (ROM), a video memory, mass storage, or cache memory such as fixed and removable media (e.g., magnetic, optical, or magnetic optical storage systems or other available mass storage technology).

Memory 220 stores support modules such as, for example, a basic input output system (BIOS), an operating system (OS), a program library, a compiler, an interpreter, and a text-processing tool. Support modules are commercially available and can be installed on computer 200 by those of skill in the art. For simplicity, these modules are not illustrated. Further, memory 220 may contain an operating system, an application routine, a program, an application-programming interface (API), and other instructions for performing the methods consistent with the invention.

Network interface 230, examples of which include Ethernet or dial-up telephone connections, may be used to communicate with computing systems on network 140. Computer system 200 may also receive input via input/output (I/O) devices 240, which may include a keyboard, pointing device, or other like input devices. Computer system 200 may also present information and interfaces via display 250 to a user.

Bus 260 may be a bidirectional system bus. For example, bus 260 may contain thirty-two address bit lines for addressing a memory 265 and thirty-two bit data lines across which data is transferred among the components. Alternatively, multiplexed data/address lines may be used instead of separate data and address lines.

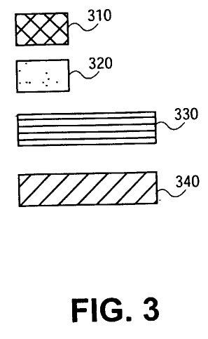

FIG. 3 is a graphical depiction of exemplary graphical elements, segments 310, 320, 330, and 340. The graphical elements 310-340 can be “bars” or segments on a web page. In one embodiment, these bars can be gif or jpg, or other images files that the browser supports. In another embodiment, the bars may be created using “span” tags, which are standard html elements. The colors and borders may be varied to create a different look for each kind of bar. The length of the bar may be used to indicate a time period.

A user interacting with the web page may move segments 310-340 in a horizontal direction across the web page, to, for example, indicate a change in shift time. In another embodiment, the segments may be moved in a vertical direction, such as to indicate levels of sound on a virtual volume control.

As seen in the Appendix, the functions that are in control of moving the bars are named “resizeLeft,” “move,” “resizeRight.” These functions resize or move the html element using html/javascript. Any computer with a browser can view these bars. Additionally, any version of the browser running on any computer system, such as Windows, Macintosh, Unix, can also use the elements.

The segments may be used to indicate a parameter on a display, such as time in a scheduling application. Segments 310, 320, 330 and 340 may represent different types of events. In the scheduling context, segment 310 may be associated with a break, segment 320 may be associated with a lunch, segment 330 may be a standard shift, and segment 340 may be an overtime shift. Each segment may be associated with different rules. Rule examples include such things as lunch segment 310 may be required to appear at a specific time, such as between 12 PM and 1 PM, and may not be moved. Standard shift segment 330 may not be able to start less then 1 hour before a lunch segment. Overtime shift segment 340 may not overlap with standard shift segment 330. Each segment is different, and the rules that govern the segment can be created through the development of the application, like the scheduling application. In another embodiment, the rules associated with the segment are stored in the database. In yet another embodiment of the application, the user of an application may generate the rules associated with the segment. In yet another embodiment, segment movement may be limited to 15-minute increments, or restricting which segments can overlap.

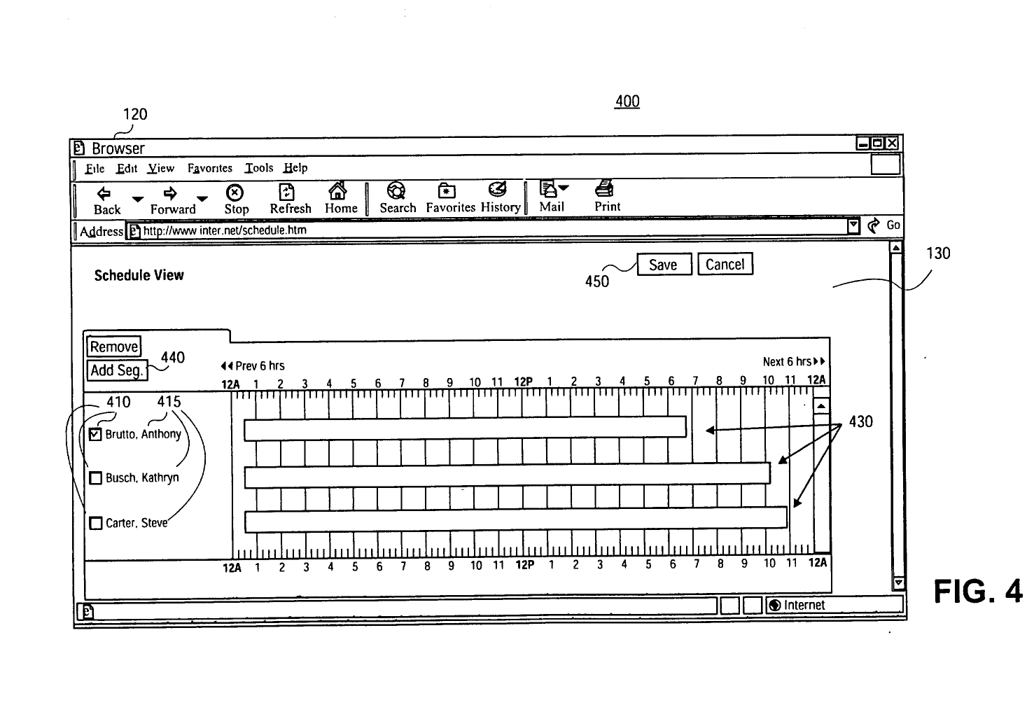

FIG. 4 is a graphical depiction of browser 120 displaying a web page 130. Browser 120 includes a web page 130 entitled “schedule.html.” Web page 130 includes a variety of graphical elements including the name 420 (e.g., “Brutto, Anthony”) and associated check box 410. Check box 410 is associated with a time field 430. Time field 430 is a field where time segments can be added. In one embodiment, time segments are added using “Add Seg.” button 440. When a user selects “Add Seg.” button 440 a segment is created. The segment may be associated with a particular user. When a segment is associated with a particular user, the segment will appear in time field 440 associated with the particular user. The segment may be given a particular type, such as being associated with a standard shift or an overtime shift. In one embodiment, the creation of the segment will prompt the entry of a type. In another embodiment, the creation of the segment will default to a type, such as regular shift. In another embodiment, a legend will allow for adding segments via drag and drop from the legend to allow the user to easily specify different types of segments.

Once the segment appears on the screen the segment may be moved from side to side to associate the segment with different time units. The segment may also be lengthened or shortened. The placement and the information associated with the segment may create a data set that needs to be stored in a database. The data set may be saved to a database when “save” button 450 is selected by the user. In another embodiment, every time the user makes a change to the display, the updated information is saved to the database. In yet another embodiment, at the end of a user session with the display, the data set of updated information may be saved to the database.

In another embodiment of displaying information, information stored in the database may be used to generate the segments displayed on web page 130. The database may include information like times for lunch and break segments to appear. The database may include regular shifts for individual workers such as “Brutto, Anthony.” When the information is displayed, the user may then select a segment and manipulate the segment, such as moving the segment from side to side to indicate new preferences for a standard shift for “Brutto, Anthony.”

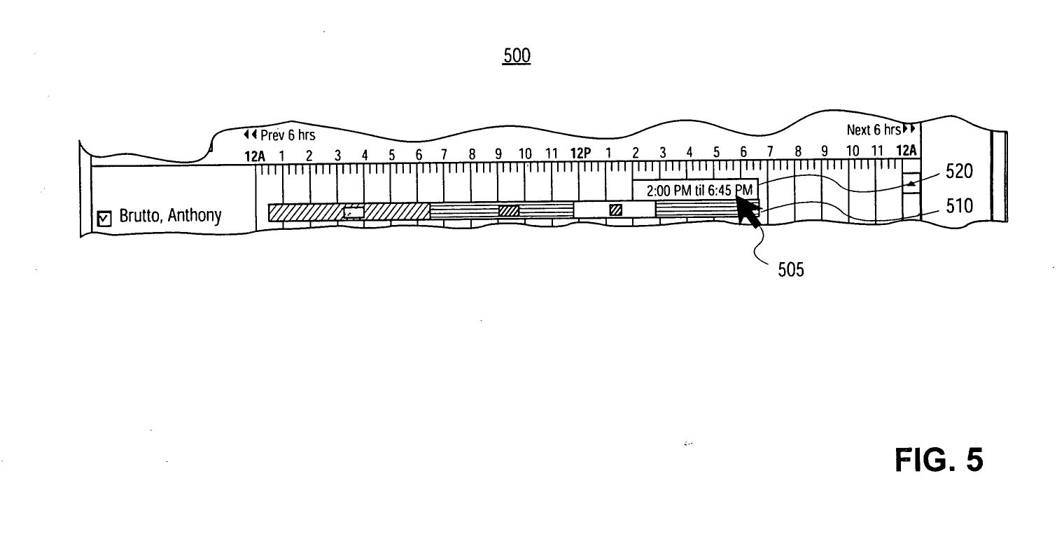

FIG. 5 is a graphical depiction of segment 510. Segment 510 is a graphical element that visually represents data. By its location, a range of times is indicated. By moving cursor 505 over segment 510, a pop-up display box 520 is created. Pop-up box 520 displays information associated with the segment, such as a time element “2:00 PM till 6:45 PM.” This information can be generated using JavaScript code such as

quickInfo.innerHTML=(minutesToTime(startTime)+“til”+minutesToTime(endTime));

The code used to generate, move, and display information associated with the segments can be found in a library, such as from a tag library. A tag library may include a number of predefined code components that can be used by a programmer creating a web page to generate a web page.

A tag library is a command that is coded into the jsp. It provides an easy way for a developer to customize the control. The developer using the tag library could call a function like this:

<%scrollingbars types=“regular shift, meal, activity, fixed shift”grain=“15” mouseoverdisplay=“yes” illegaloverlapping=“(regular shift, fixed shift),(meal,activity)”%>

The types could be used to specify which types of segments are shown. The grain could be to specify the increment of minutes used. The mouseoverdisplay specifies whether a mouseover should be shown. The illegaloverlapping specifies which segments cannot overlap. There could be more fields allowing much customization. When a user views a screen that contains this tag, the tag would be converted into the equivalent set of html/javascript like the code we have gone over. The tag provides an easy way for another developer to use and customize this control without having to know or understand the underlying mechanics.

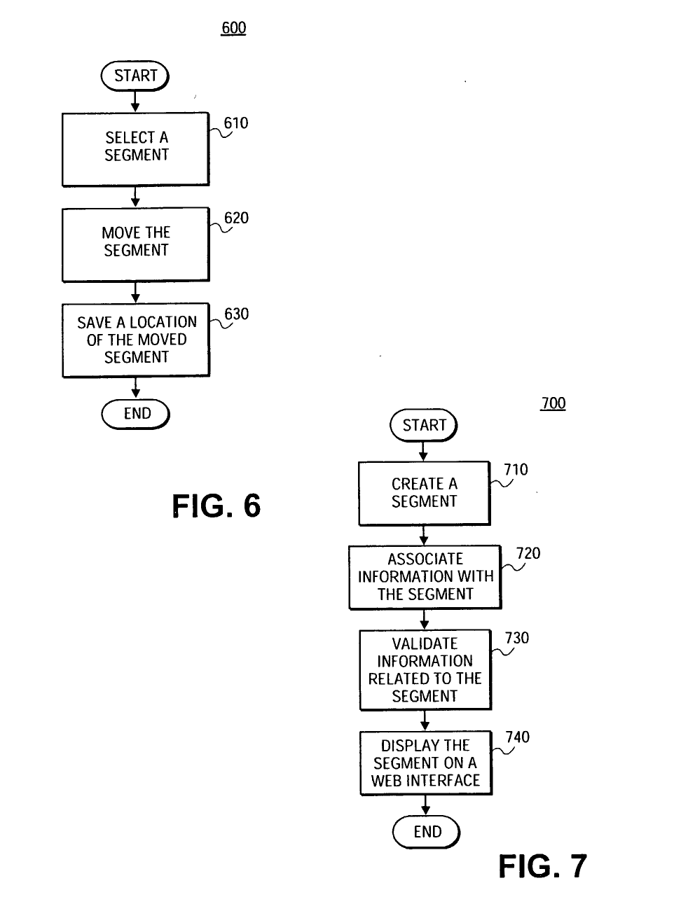

FIG. 6. is a flow diagram illustrating a method for moving a segment, such as segment 510 from FIG. 5 in a manner consistent with the present invention. In one embodiment, the method is performed in system architecture 100 (see FIG. 1). Initially, a user will select a segment that is being displayed on a browser in a web page (step 610). The user may select the segment by moving a cursor over the displayed segment and selecting the segment. In another embodiment, the user may select the segment by creating a new segment. The segment may then be moved (step 620). The segment may be moved by the user moving the cursor in one direction, such as to the right or to the left. The segment will then follow the cursor movement and move in the direction the cursor moved. In one embodiment, this is performed using the functions called “move,” as illustrated in the Appendix. As the segment is moved, new information is associated with the segment, such as a new set of time intervals. The segment may also be moved by lengthening or shortening the segment. In one embodiment, this is performed using the functions called resizeLeft and resizeRight, as illustrated in the Appendix. Once the segment is moved, or slide to a new location, the new location information of the moved segment is saved (step 630). The information may be saved as soon a user unselects the segment. In another embodiment the information may be saved when the user clicks a save button.

FIG. 7. is a flow diagram illustrating a method for displaying a segment, such as segment 510 from FIG. 5 in a manner consistent with the present invention. In one embodiment, the method is performed in system architecture 100 (see FIG. 1). Web page 130 is displayed in browser 120. A user (not shown) wishes to indicate information. A segment 510 is created by the browser using the rules indicated in the “schedule.html” file (step 710). These rules can be written in html code, JavaScript codes, or be a part of the tag library. In one embodiment, the rules are about which bars cannot overlap or move in certain ways is configured in the templates used to create the bars, as illustrated in the defined functional feature of the function createFixedTemplate in the Appendix.

Information is associated with the segment (step 720). Information is gathered from a database or from indicated user actions such as times in which workers will be working standard shifts. A user can select segment 510 and move it a certain number of hours, lengthen it, shorten it, or associate more information with it.

Once associated with a segment, information is validated (step 730).

Validation occurs by, for example, checking if the new location and information associated with the segment do not break any of the rules. Rules can limit movement, such as limiting segment movement to 15-minute increments. Rules can also restrict which segments can overlap. In another embodiment validation forces one type of segment to exist within the times of another segment. In one embodiment, a lunch segment 310 exists inside a standard shift 330 and cannot be moved outside the enclosing shifts time range. Types of segments can also be configured to enable/disable resizing left, resizing right, or moving.

After validation, the segment is displayed on the web interface (step 740). If a segment is being moved and it has not been validated then the segment can be placed in the original valid positions or in a nearby valid position.

Furthermore, although aspects of the present invention are described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the method of the present invention may conveniently be implemented in program modules that are based upon the flow charts in FIGS. 6 and 7. No particular programming language has been indicated for carrying out the various procedures described above because it is considered that the operations, stages and procedures described above and illustrated in the accompanying drawings are sufficiently disclosed to permit one of ordinary skill in the art to practice the instant invention. Moreover, there are many computers and operating systems that may be used in practicing the instant invention and therefore no detailed computer program could be provided which would be applicable to these many different systems. Each user of a particular computer will be aware of the language and tools which are most useful for that user's needs and purposes.

The above-noted features and principles of the present invention may be implemented in various environments. Such environments and related applications may be specially constructed for performing the various processes and operations of the invention or they may include a general purpose computer or computing platform selectively activated or reconfigured by program code to provide the necessary functionality. The processes disclosed herein are not inherently related to any particular computer or other apparatus, and aspects of these processes may be implemented by a suitable combination of hardware, software, and/or firmware. For example, various general purpose machines may be used with programs written in accordance with teachings of the invention, or it may be more convenient to construct a specialized apparatus or system to perform the required methods and techniques.

Embodiments of the present invention also relate to computer readable media that include program instructions or program code for performing various computer-implemented operations based on the methods and processes of the invention. The program instructions may be those specially designed and constructed for the purposes of the invention, or they may be of the kind well-known and available to those having skill in the computer software arts. Examples of program instructions include for example machine code, such as produced by a compiler, and files containing a high level code that can be executed by the computer using an interpreter.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

### APPENDIX

The following is exemplary code used to implement methods disclosed herein. The following code, however, can be translated or implemented in other appropriate programming languages. Furthermore, the following code is subject to copyright protection in which the copyright owner reserves all copyrights contained herein.

```
/**
        Start moving bar, start the appropriate move operation
*/
function startMove( )
{
        if(null == pickedElement.id)
        {
                return;
        }
        var bar = document.getElementById(pickedElement.id);
        switch (pickedElement.movement)
        {
      case “left”:
          resizeLeft(bar);
          break;
      case “middle”:
          move(bar);
          break;
      case “right”:
          resizeRight(bar);
          break;
    }
}
/**
        Function us when dragging the right side of the
        bar to make it longer or shorter
*/
function resizeRight(bar)
{
        if(bar.id == pickedElement.id)
        {
            var middleBar = bar.childNodes[0].childNodes[1];
            var maxPosition = END;
            var edges = bar.offsetWidth − middleBar.style.posWidth;
            var maxWidth = END − pickedElement.barLocation − (bar.offsetWidth −
middleBar.style.posWidth);
            var newWidth = pickedElement.middleWidth −
pickedElement.pickedLocation + window.event.clientX;
            var minWidth = GRAIN − (edges % GRAIN);
            if(maxWidth < newWidth)
            {
                    middleBar.style.posWidth = maxWidth − ((maxWidth + edges) %
GRAIN);
            }
            else if(minWidth >= newWidth)
            {
                    middleBar.style.posWidth = minWidth;
            }
            else
            {
                    middleBar.style.posWidth = newWidth − ((newWidth + edges) %
GRAIN);
            }
            showGraphInfo(bar);
        }
        window.event.returnValue = false;
    window.event.cancelBubble = true;
}
/**
        Function called to drag the entire bar with mouse
*/
function move(bar)
{
        if(bar.id == pickedElement.id)
        {
            var minPosition = 0;
            var maxPosition;
            if(null != bar.parentBar) // if bar is within a parent, make the parent its
bounds
        {
                    minPosition = bar.parentBar.style.posLeft;
                    maxPosition = minPosition + bar.parentBar.offsetWidth;
            }
            else // bar can move throughout entire graph
            {
                    maxPosition = END;
            }
            var originalPosition = bar.style.posLeft;
            // calculate new position of bar and set the bar to it
            var newPosition = window.event.clientX −
pickedElement.leftClickOffset;
            if(newPosition <= minPosition)
            {
                bar.style.posLeft = validX(minPosition);
            }
            else if((newPosition + bar.offsetWidth) >= maxPosition)
            {
                bar.style.posLeft = validX(maxPosition − bar.offsetWidth);
            }
            else
            {
                    bar.style.posLeft = validX(newPosition);
            }
            // move bar's children the same amount as the bar
            var posDiff = bar.style.posLeft − originalPosition
            for(var i=0; i<bar.childrenBars.length; i++)
            {
                    bar.childrenBars[i].style.posLeft += posDiff;
            }
            // display information box
            showGraphInfo(bar);
        }
    window.event.returnValue = false;
    window.event.cancelBubble = true;
}
/**
        Function to change the bar start time
*/
function resizeLeft(bar)
{
        if(bar.id == pickedElement.id)
        {
            var middleBar = bar.childNodes[0].childNodes[1];
            var edges = bar.offsetWidth − middleBar.style.posWidth;
            var maxWidth = pickedElement.barLocation +
pickedElement.middleWidth;
            var newWidth = pickedElement.middleWidth +
pickedElement.pickedLocation − window.event.clientX;
            var minWidth = GRAIN − (edges % GRAIN);
            if(maxWidth < newWidth)
            {
                    middleBar.style.posWidth = maxWidth − ((maxWidth + edges) %
GRAIN);
            }
            else if(minWidth > newWidth)
            {
                    middleBar.style.posWidth = minWidth;
            }
            else
            {
                    middleBar.style.posWidth = newWidth − ((newWidth + edges) %
GRAIN);
            }
            bar.style.posLeft = pickedElement.barLocation − (bar.offsetWidth −
pickedElement.barWidth);
            showGraphInfo(bar);
        }
        window.event.returnValue = false;
    window.event.cancelBubble = true;
}
/**
        Function with Rules
*/
function createFixedShiftTemplate(barType)
{
        //========= define appearane ================
        var outerElement = document.createElement(“span”);
        outerElement.style.position = “absolute”;
        outerElement.style.fontSize = 0;
        outerElement.style.posTop = 2;
        outerElement.style.borderTop = “1px solid #EED4D8”;
        outerElement.style.borderLeft = “1px solid #EED4D8”;
        outerElement.style.borderRight = “1px solid #996666”;
        outerElement.style.borderBottom = “1px solid #996666”;
        outerElement.style.zIndex = 150;
        var leftElement = document.createElement(“span”);
        leftElement.style.fontSize = 0;
        leftElement.style.backgroundColor = “#D3A4A7”;
        leftElement.style.borderBottom = “1px solid #AE9090”;
        leftElement.style.posWidth = 5;
        leftElement.style.posHeight = 10;
        var middleElement = document.createElement(“span”);
        middleElement.style.fontSize = 0;
        middleElement.style.backgroundColor = “#D3A4A7”;
        middleElement.style.borderBottom = “1px solid #AE9090”;
        middleElement.style.posWidth = 100;
        middleElement.style.posHeight = 10;
        var rightElement = document.createElement(“span”);
        rightElement.style.fontSize = 0;
        rightElement.style.backgroundColor = “#D3A4A7”;
        rightElement.style.borderBottom = “1px solid #AE9090”;
        rightElement.style.posWidth = 5;
        rightElement.style.posHeight = 10;
        //========= define functional features ============
        outerElement.barType = barType;
        outerElement.isMobile = true;
        outerElement.isResizable = true;
        outerElement.noOverlap = new Array(“RegularShift”, “FixedShift”,
“InactiveShift”, “InactiveShiftNoCoverage”, “InactiveShiftCoverage”, “TimeOff”,
“Unavailable”);
        outerElement.coverageAction = “add”;
        outerElement.shiftSort = true;
        //========= put elements together =================
        var nobr = document.createElement(“nobr”);
        nobr.appendChild(leftElement);
        nobr.appendChild(middleElement);
        nobr.appendChild(rightElement);
        outerElement.appendChild(nobr);
        templates[barType] = outerElement;
}
```

What is claimed is:

1. A method for a client, comprising:
receiving into a web page, a segment with information;
receiving code for manipulating the segment, the code for manipulating the segment receiving a manipulation command; and
displaying the manipulation of the segment in the web page.

2. The method of claim 1, wherein receiving the web page further comprises receiving display code for displaying a box that indicates the segment information when the user moves a pointing device over the segment.

3. The method of claim 1, wherein the code for manipulating the segment, executes an action including at least one of resizing the segment to the left, resizing the segment to the right, moving the segment, and dragging the segment.

4. The method of claim 1, wherein receiving code is performed by loading code components from a library.

5. The method of claim 4, wherein the library is a tag library.

6. A method for a server, comprising:
providing a web page;
inserting into a web page, a segment with information;
inserting code for manipulating the segment, the code for manipulating the segment receiving a manipulation command; and
inserting code for displaying the manipulation of the segment on the web page.

7. The method of claim 6, wherein providing the web page further comprises inserting display code for displaying a box that indicates the segment information when the user moves a pointing device over the segment.

8. The method of claim 6, wherein the code for manipulating the segment, executes an action including at least one of resizing the segment to the left, resizing the segment to the right, moving the segment, and dragging the segment.

9. The method of claim 6, wherein inserting code is performed by loading code components from a library.

10. The method of claim 9, wherein the library is a tag library.

11. A method for dynamically manipulating a segment in an Internet Application, comprising:
selecting the segment with representative information;
moving the segment, wherein the representative information is modified.

12. The method of claim 11, further comprising:
creating a segment.

13. The method of claim 11, further comprising,
associating representative information with the segment.

14. The method of claim 11, further comprising:
storing the representative information in a database.

15. The method of claim 11, further comprising:
checking for segment movement restriction.

16. The method of claim 11, wherein manipulation comprises at least one of resize and move.

17. The method in claim 11, wherein the segment is manipulated using JavaScript.

18. The method of claim 11, wherein manipulating the segment is performed by loading code components from a library.

19. The method of claim 18, wherein the library is a tag library.

20. A method for visually displaying information on a web interface, comprising:
creating a segment with associated information;
validating the associated information; and
displaying the segment on the web interface.

21. The method as in claim 20, wherein validating the information further comprises comparing the values associated with the segment with a rule.

22. The method as in claim 21, wherein the rule limit movement of a segment to specific time increments.

23. The method as in claim 21, wherein the rule restrict the segment from overlap.

24. The method as in claim 21, wherein the rule forces the segment to exist within another segment.

25. The method as in claim 20, further comprising:
storing the segment.

26. The method as in claim 25, wherein storing the segment stores the information associated with the segment in a database.

27. The method as in claim 20, wherein the information is generated from a database.

28. The method in claim 20, wherein the segment is generated using JavaScript.

29. The method in claim 20, wherein the segment is generated using code from a tag library.

30. A computer system comprising:
a memory having program instructions; and
a processor, responsive to the programming instructions, configured to:
receive into a web page, a segment with information;
receive code for manipulating the segment, the code for manipulating the segment receiving a manipulation command; and
display the manipulation of the segment in the web page.

31. The system of claim 30, wherein program instruction to receive the web page further comprises instruction to receive display code to display a box that indicates the segment information when the user moves a pointing device over the segment.

32. The system of claim 30, wherein the code for manipulating the segment, executes an action including at least one of resizing the segment to the left, resizing the segment to the right, moving the segment, and dragging the segment.

33. The system of claim 30, wherein program instruction to receive code is performed by loading code components from a library.

34. The system of claim 33, wherein the library is a tag library.

35. A computer system comprising:
a memory having program instructions; and
a processor, responsive to the programming instructions, configured to:
providing a web page;
inserting into the web page, a segment with information;
inserting code for manipulating the segment, the code for manipulating the segment receiving a manipulation command; and
inserting code for displaying the manipulation of the segment on the web page.

36. The system of claim 35, wherein program instruction to provide the web page further comprises program instruction to insert display code for displaying a box that indicates the segment information when the user moves a pointing device over the segment.

37. The system of claim 35, wherein the code for manipulating the segment, executes an action including at least one of resizing the segment to the left, resizing the segment to the right, moving the segment, and dragging the segment.

38. The system of claim 35, wherein program instruction to insert code is performed by loading code components from a library.

39. The system of claim 38, wherein the library is a tag library.

40. A computer system for dynamically manipulating a segment in an Internet Application, comprising:
a memory having program instructions; and
a processor, responsive to the programming instructions, configured to:
select the segment with representative information;
move the segment, wherein the representative information is modified.

41. The system of claim 40, wherein the processor is further configured to create a segment.

42. The method of claim 40, wherein the processor is further configured to associate representative information with the segment.

43. The method of claim 40, wherein the processor is further configured to store representative information in a database.

44. The method of claim 40, wherein the processor is further configured to check for segment movement restrictions.

45. The method of claim 40, wherein manipulation comprises at least one of resize and move.

46. The method in claim 40, wherein the segment is manipulated using JavaScript.

47. The method of claim 40, wherein manipulating the segment is performed by loading code components from a library.

48. The method of claim 47, wherein the library is a tag library.

49. A computer system for visually displaying information on a web interface, comprising:
a memory having program instructions; and
a processor, responsive to the programming instructions, configured to:
create a segment with associated information;
validate the associated information; and
display the segment on the web interface.

50. The method as in claim 49, wherein the instruction to validate the information further comprises comparing the values associated with the segment with a rule.

51. The method as in claim 50, wherein the rule limit movement of a segment to specific time increments.

52. The method as in claim 50, wherein the rule restrict the segment from overlap.

53. The method as in claim 50, wherein the rule forces the segment to exist within another segment.

54. The method as in claim 49, wherein the processor is further configured to store the segment.

55. The method as in claim 54, wherein the instruction to store the segment stores the information associated with the segment in a database.

56. The method as in claim 54, wherein the information is generated from a database.

57. The method in claim 54, wherein the segment is generated using JavaScript.

58. The method in claim 54, wherein the segment is generated using code from a tag library.

59. A computer program product embodied on a computer usable medium, the computer program product comprising:
instructions to a client for receiving into a web page, a segment with information;
instructions at the client for receiving code for manipulating the segment, the code for manipulating the segment receiving a manipulation command; and
instructions at the client for displaying the manipulation of the segment in the web page.

60. A computer program product embodied on a computer usable medium, the computer program product comprising:
instructions to provide a web page;
instructions to insert into the web page, a segment with information;
instructions to insert code for manipulating the segment, the code for manipulating the segment receiving a manipulation command; and
instructions to insert code for displaying the manipulation of the segment on the web page.

61. A computer-readable medium on which is stored instructions, which when executed performs steps in a method for dynamically manipulating a segment in an Internet Application, the steps comprising:
selecting the segment with representative information;
moving the segment, wherein the representative information is modified.

62. A computer-readable medium on which is stored instructions, which when executed performs steps in a method for visually displaying information on a web interface, the steps comprising:
creating a segment with associated information;
validating the associated information; and
displaying the segment on the web interface.
